(19) United States
(12) Patent Application Publication
(10) Pub. No.: US 2018/0049013 A1
(43) Pub. Date: Feb. 15, 2018

(54) METHOD AND DEVICE FOR EXECUTING SERVICE DISCOVERY IN WIRELESS COMMUNICATION SYSTEM

(71) Applicant: LG ELECTRONICS INC., Seoul (KR)

(72) Inventors: Byungjoo Lee, Seoul (KR); Dongcheol Kim, Seoul (KR); Giwon Park, Seoul (KR); Hyunhee Park, Seoul (KR); Taesung Lim, Seoul (KR)

(21) Appl. No.: 15/557,983

(22) PCT Filed: Mar. 17, 2016
(86) PCT No.: PCT/KR2016/002685

§ 371 Date: Sep. 13, 2017

Related U.S. Application Data
(60) Provisional application No. 62/134,604, filed on Mar. 18, 2015.

(51) Int. Cl. H04W 8/00; H04W 76/02

(52) U.S. Cl. CPC H04W 8/005; H04W 76/023; H04W 92/18

(57) ABSTRACT

The present specification pertains to a method for executing service discovery by means of a first type advertiser device in a wireless communication system, wherein the method may comprise the steps of: receiving a probe request message from a searcher device; determining the type of the searcher device on the basis of the received probe request message; and transmitting a probe response message to the searcher device. Here, the first type advertiser device may execute service discovery with at least one or more of a first type searcher device and a second type searcher device. Here, identification information corresponding to the determined type may be included in the probe response message.

### TECHNICAL FIELD

The present specification relates to a wireless communication system, and more particularly, to a method of performing service discovery in a wireless communication system and an apparatus therefor.

### BACKGROUND ART

Wireless access systems have been widely deployed to provide various types of communication services such as voice or data. In general, a wireless access system is a multiple access system that may support communication of multiple users by sharing available system resources (e.g., a bandwidth, transmission power, etc.). For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a multi carrier frequency division multiple access (MC-FDMA) system.

Recently, various wireless communication technologies have been developed with the advancement of information communication technology. Among the wireless communication technologies, a wireless local area network (WLAN) is the technology capable of accessing the Internet by wireless in a home, a company or a specific service provided area through portable device such as a personal digital assistant (PDA), a laptop computer, a portable multimedia player (PMP), etc. based on a radio frequency technology.

A standard for a WLAN (wireless local area network) technology is developing by IEEE (institute of electrical and electronics engineers) 802.11 group. IEEE 802.11a and b use an unlicensed band on 2.4 GHz or 5 GHz, IEEE 802.11b provides transmission speed of 11 Mbps and IEEE 802.11a provides transmission speed of 54 Mbps. IEEE 802.11g provides transmission speed of 54 Mbps by applying OFDM (orthogonal frequency division multiplexing) on 2.4 GHz. IEEE 802.11n provides transmission speed of 300 Mbps by applying MIMO-OFDM (multiple input multiple output -orthogonal frequency division multiplexing). IEEE 802.11n supports a channel bandwidth up to 40 MHz. In this case, transmission speed can be provided as fast as 600 Mbps. IEEE 802.11p corresponds to a standard for supporting WAVE (wireless access in vehicular environments). For instance, 802.11p provides improvement necessary for supporting ITS (intelligent transportation systems). IEEE 802.11ai corresponds to a standard for supporting fast initial link setup of IEEE 802.11 station.

A DLS (direct link setup)-related protocol in wireless LAN environment according to IEEE 802.11e is used on the premise of a QBSS (quality BSS) supporting QoS (quality of service) supported by a BSS (basic service set). In the QBSS, not only a non-AP STA but also an AP corresponds to a QAP (quality AP) supporting QoS. Yet, in current commercialized wireless LAN environment (e.g., wireless LAN environment according to IEEE 802.11a/b/g etc.), although a non-AP STA corresponds to a QSTA (quality STA) supporting QoS, most of APs corresponds to a legacy AP incapable of supporting QoS. Consequently, in the current commercialized wireless LAN environment, there is a limit in that a QSTA is unable to use a DLS service.

In a recent situation that such a wireless short-range communication technology as Wi-Fi and the like is widely applied to a market, connection between devices is performed not only based on a local network but also based on direct connection between devices. One of technologies enabling devices to be directly connected is Wi-Fi Direct.

Wi-Fi Direct corresponds to a network connectivity standard technology describing up to operations of a link layer. Since there is no definition on a regulation or a standard for an application of a higher layer, it is difficult to have compatibility and consistency of an operation after Wi-Fi Direct devices are connected with each other. For this reason, such a standard technology including higher layer application technology as WFDS (Wi-Fi Direct service) is under discussion by WFA (Wi-Fi alliance).

The WFA has announced such a new standard for delivering data via a direct connection between mobile devices as Wi-Fi Direct. Hence, related industries are actively developing a technology for satisfying the Wi-Fi Direct standard. In a strict sense, the Wi-Fi Direct is a marketing terminology and corresponds to a brand name A technology standard for the Wi-Fi Direct is commonly called Wi-Fi P2P (peer to peer). Hence, the present invention describing Wi-Fi-based P2P technology may be able to use Wi-Fi Direct and Wi-Fi P2P without any distinction. In a legacy Wi-Fi network, a user accesses the legacy Wi-Fi network via an AP (access point) and accesses the Internet to use a device on which Wi-Fi is mounted. A data communication method via direct connection between devices is also used in a legacy communication by some users in a manner of being mounted on a device (e.g., a cellular phone, a note PC, etc.) on which a wireless communication technology such as Bluetooth is mounted. Yet, according to the data communication method, transmission speed is slow and transmission distance is limited to within 10 m. In particular, when the data communication method is used for transmitting massive data or is used in environment at which many Bluetooth devices exist, there exists a technical limit in performance capable of being felt by a user.

Meanwhile, Wi-Fi P2P maintains most of functions of the legacy Wi-Fi standard and includes an additional part for supporting direct communication between devices. Hence, the Wi-Fi P2P can sufficiently utilize hardware and physical characteristics of a device on which a Wi-Fi chip is mounted and is able to provide device-to-device P2P communication by upgrading a software function only.

As widely known, the device on which the Wi-Fi chip is mounted is extending to various ranges including a note PC, a smartphone, a smart TV, a game console, a camera and the like. For the device, sufficient numbers of suppliers and technology development personnel have been formed. Yet, software development supporting the Wi-Fi P2P standard is not vitalized yet. This is because, although a Wi-Fi P2P standard is announced, related software capable of conveniently using the Wi-Fi P2P standard is not distributed.

There exists a device playing a role of an AP in a legacy infrastructure network in a P2P group. The device is called a P2P group owner (GO) in a P2P standard. Various P2P clients may exist on the basis of the P2P GO. One GO exists in a single P2P group only and all remaining devices become client devices.

Recently, the use of Bluetooth, NAN (neighboring awareness networking), and NFC (near field communication) is increasing. Hence, it is necessary to have a method of providing a service in environment in which a plurality of systems or interfaces are provided.

### DISCLOSURE OF THE INVENTION

### Technical Tasks

One object of the present specification is to provide a method of performing service discovery in a wireless communication system and an apparatus therefor.

Another object of the present specification is to provide a method of performing service discovery based on a device type used in a wireless communication system.

The other object of the present specification is to provide a method of identifying identification information used for discovering a service in consideration of compatibility with a different interface and an apparatus therefor.

### Technical Solution

To achieve these and other advantages and in accordance with the purpose of the present invention, as embodied and broadly described, according to one embodiment, a method of performing service discovery, which is performed by a first type advertiser device in a wireless communication system, include the steps of receiving a probe request message from a seeker device, determining a type of the seeker device based on the received probe request message, and transmitting a probe response message to the seeker device. In this case, the first type advertiser device can perform the service discovery with at least one of a first type seeker device and a second type seeker device. In this case, the probe response message can include identification information corresponding to the determined type.

To further achieve these and other advantages and in accordance with the purpose of the present invention, according to a different embodiment, a first type advertiser device performing service discovery in a wireless communication system includes a reception module configured to receive information from an external device, a transmission module configured to transmit information to an external device, and a processor configured to control the reception module and the transmission module, the processor configured to receive a probe request message from a seeker device, the processor configured to determine a type of the seeker device based on the received probe request message, the processor configured to transmit a probe response message to the seeker device. In this case, the first type advertiser device can perform the service discovery with at least one of a first type seeker device and a second type seeker device. In this case, the probe response message can include identification information corresponding to the determined type.

Following items can be commonly applied to the method of performing the service discovery using the first type advertiser device in a wireless communication system and an apparatus therefor.

The first type advertiser device performs the service discovery with the first type seeker device using first type identification information and the first type advertiser device can perform the service discovery with the second type seeker device using second type identification information.

The first type identification information may correspond to identification information which is configured based on a service hash and the second type identification information may correspond to identification information which is configured based on a WFD IE (Wi-Fi display information element).

If the first type identification information is included in the probe request message, the first type advertiser device determines the seeker device as the first type seeker device and can transmit the probe response message in a manner of including the first type identification in the probe response message.

If the first type identification information is included in the probe request message, the second type identification information may not be included in the probe request message.

If the first type advertiser device performs the service discovery with the first type seeker device, the first type advertiser device and the first type seeker device can perform the service discovery based on a service application platform.

If the second type identification information is included in the probe request message, the first type advertiser device determines the seeker device as the second type seeker device and can transmit the probe response message in a manner of including the second type identification in the probe response message.

If the second type identification information is included in the probe request message, the first type identification information may not be included in the probe request message.

The first type advertiser device can further perform the service discovery with a third type seeker device based on third type identification information. In this case, if the first type advertiser device determines the seeker device as the third type seeker device, the third type identification information can be included in the probe response message.

The third type identification information can be configured based on a service hash

To further achieve these and other advantages and in accordance with the purpose of the present invention, according to a further different embodiment, a method of performing service discovery, which is performed by a first type seeker device in a wireless communication system, includes the steps of transmitting a probe request message to an advertiser device, and receiving a probe response message from the advertiser device based on the probe request message. In this case, the first type seeker device can perform the service discovery with at least one of a first type advertiser device and a second type advertiser device. In this case, the probe request message can include both first type identification information and second type identification information.

To further achieve these and other advantages and in accordance with the purpose of the present invention, according to a further different embodiment, a first type seeker device performing service discovery in a wireless communication system includes a reception module configured to receive information from an external device, a transmission module configured to transmit information to an external device, and a processor configured to control the reception module and the transmission module, the processor configured to transmit a probe request message to an advertiser device, the processor configured to receive a probe response message from the advertiser device based on the probe request message. In this case, the first type seeker device can perform the service discovery with at least one of a first type advertiser device and a second type advertiser device. In this case, the probe request message can include both first type identification information and second type identification information.

Following items can be commonly applied to the method of performing the service discovery using the first type seeker device and an apparatus therefor.

The first type seeker device can perform the service discovery with a third type advertiser device. In this case, the probe request message can further include third type identification information together with the first type identification information and the second type identification information.

The method can further include the step of determining a type of the advertiser device based on the received probe response message.

### ADVANTAGEOUS EFFECTS

According to the present specification, it is able to provide a method of performing service discovery in a wireless communication system and an apparatus therefor.

According to the present specification, it is able to provide a method of performing service discovery based on a device type used in a wireless communication system.

According to the present specification, it is able to provide a method of identifying identification information used for discovering a service in consideration of compatibility with a different interface and an apparatus therefor.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

FIG. 1 is a diagram for an example of a structure of IEEE 802.11 system to which the present invention is applicable;

FIG. 2 is a block diagram for an example of operations of a communication system adopting access devices and wireless user devices;

FIG. 3 is a diagram for an example of a WFD (Wi-Fi Direct) network;

FIG. 4 is a flowchart for an example of a process of configuring a WFD network;

FIG. 5 is a diagram for a typical P2P network topology;

FIG. 6 is a diagram for a situation that a single P2P device forms a P2P group and is connected with an AP in a manner of operating as an STA of WLAN at the same time;

FIG. 7 is a diagram for a WFD network aspect in case that P2P is applied;

FIG. 8 is a simplified block diagram for a WI-DS (Wi-Fi Direct services) device;

FIG. 9 is a flowchart for a process of establishing a WFDS session by discovering a device and a service between WFDS devices in a legacy WI-DS;

FIG. 10 is a diagram for a service application platform (ASP) supporting a plurality of interfaces;

FIG. 11 is a diagram of a method for a first type device to perform service discovery with at least one device selected from the group consisting of a different first type device, a second type device, and a third type device;

FIG. 12 is a diagram of a method for a first type device and a second type device to perform service discovery;

FIG. 13 is a diagram of a method for a first type seeker device to perform service discovery with a third type advertiser device;

FIG. 14 is a diagram of a method for a first type seeker device and a first type advertiser device to perform service discovery;

FIG. 15 is a diagram of a method for a first type seeker device to perform service discovery with an advertiser device. FIG. 16 is a diagram of a method for a first type advertiser device to perform service discovery with a seeker device;

FIG. 17 is a flowchart of a method for a device to support a service using an application service platform according to one embodiment of the present specification;

FIG. 18 is a flowchart of a method for a device to support a service using an application service platform according to one embodiment of the present specification;

FIG. 19 is a block diagram for a device according to one embodiment of the present specification.

### BEST MODE

### Mode for Invention

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide the full understanding of the present invention. However, it will be apparent to those skilled in the art that the present invention may be implemented without such specific details.

The following embodiments can be achieved by combinations of structural elements and features of the present invention in prescribed forms. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment.

Specific terminologies in the following description are provided to help the understanding of the present invention. And, these specific terminologies may be changed to other formats within the technical scope or spirit of the present invention.

Occasionally, to avoid obscuring the concept of the present invention, structures and/or devices known to the public may be skipped or represented as block diagrams centering on the core functions of the structures and/or devices. In addition, the same reference numbers will be used throughout the drawings to refer to the same or like parts in this specification.

The embodiments of the present invention can be supported by the disclosed standard documents disclosed for at least one of wireless access systems including IEEE 802 system, 3GPP system, 3GPP LTE system, LTE-A (LTE-Advanced) system and 3GPP2 system. In particular, the steps or parts, which are not explained to clearly reveal the technical idea of the present invention, in the embodiments of the present invention may be supported by the above documents. Moreover, all terminologies disclosed in this document can be supported by the above standard documents.

The following embodiments of the present invention can be applied to a variety of wireless access technologies, for example, CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc.

Although the terms such as “first” and/or “second” in this specification may be used to describe various elements, it is to be understood that the elements are not limited by such terms. The terms may be used to identify one element from another element. For example, a first element may be referred to as a second element, and vice versa within the range that does not depart from the scope of the present invention.

In the specification, when a part “comprises” or “includes” an element, it means that the part further comprises or includes another element unless otherwise mentioned. Also, the terms “. . . unit”, “. . . module” disclosed in the specification means a unit for processing at least one function or operation, and may be implemented by hardware, software or combination of hardware and software.

For clarity, the following description focuses on IEEE 802.11 systems. However, technical features of the present invention are not limited thereto.

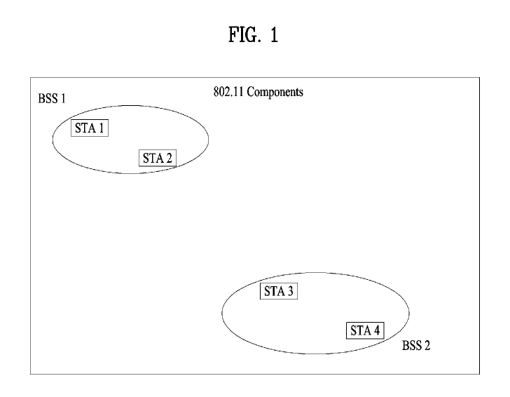

FIG. 1 is a diagram for an example of a structure of IEEE 802.11 system to which the present invention is applicable.

IEEE 802.11 structure can consist of a plurality of configuration elements and a WLAN supporting mobility of an STA, which is transparent to an upper layer, can be provided by interaction of a plurality of the configuration elements. A basic service set (hereinafter abbreviated BSS) may correspond to a basic configuration block in IEEE 802.11 LAN. FIG. 1 shows an example that there exist two BSSs (BSS 1 and BSS 2) and two STAs are included in each of the BSSs as members, respectively (STA 1 and STA 2 are included in the BSS 1 and STA 3 and STA 4 are included in the BSS 2). In this case, an STA indicates a device operating according to MAC (medium access control)/PHY (physical) standard of IEEE 802.11. An STA includes an AP (access point) STA (simply, an AP) and a non-AP STA. An AP corresponds to a device providing network access (e.g., WLAN) to a non-AP STA via a wireless interface. The AP can be configured by a fixed form or a mobile form and includes a mobile wireless device (e.g., a laptop computer, a smartphone, etc.) providing a hot-spot. The AP corresponds to a base station (BS), a Node-B, an evolved Node-B (eNB), a base transceiver system (BTS), a femto BS and the like in a different wireless communication field. The non-AP STA corresponds to a device directly controlled by a user such as a laptop computer, a PDA, a wireless modem, a smartphone and the like. The non-AP STA can be called a device, a wireless transmit/receive unit (WTRU), a user equipment (UE), a mobile station (MS), a mobile device, a mobile subscriber station (MSS), and the like.

An oval indicating a BSS in FIG. 1 may be comprehended as a coverage area of the STAs included in the BSS to maintain a communication. This area can be called a basic service area (hereinafter abbreviated BSA). A BSS of a most basic type in IEEE 802.11 LAN may correspond to an independent BSS (hereinafter abbreviated IBSS). For instance, the IBSS may have a minimum form consisting of two STAs only. The BSS (BSS 1 or BSS 2), which is the simplest form and omitted different configuration elements, in FIG. 1 may correspond to a representative example of the IBSS. This sort of configuration is available when the STAs are able to directly communicate with each other. And, this kind of LAN can be configured when a LAN is necessary instead of being configured in advance. Hence, this network may be called an ad-hoc network.

When power of an STA is turned on or turned off or an STA enters into a BSS area or gets out of the BSS area, a membership of the STA in a BSS can be dynamically changed. In order to be a member of the BSS, the STA can join the BSS using a synchronization process. In order to access all services based on a BSS structure, the STA can be associated with the BSS.

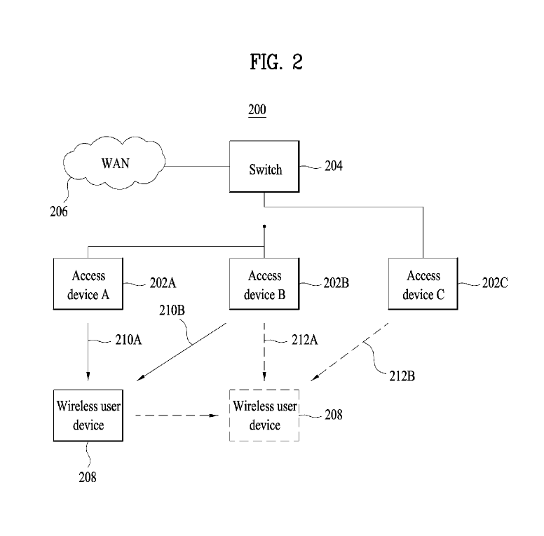

FIG. 2 is a block diagram for an example of a communication system 200 adopting access devices (e.g., AP STAs) 220A/202B/202C and wireless user devices (e.g., non-AP STAs).

Referring to FIG. 2, access devices 202A to 202C are connected with a switch 204 providing access to a WAN (wide area network) 206 such as the Internet. Each of the access devices 202A to 202C provides wireless access to wireless devices belonging to a coverage area (not depicted) of the access device via a time division multiplexed network. Hence, the access devices 202A to 202C commonly provide a total WLAN coverage area of the system 200. For instance, a wireless device 208 may exist in a coverage area of the access devices 202A and 202B in a position represented by a box of a line. Hence, the wireless device 208 can receive beacons from each of the access devices 202A/202B as shown by line arrows 210A and 210B. If the wireless device 208 roams to a dotted line box from the line box, the wireless device 208 enters a coverage area of the access device 202C and leaves a coverage area of the access device 202A. Hence, as shown by dotted lines 212A and 212B, the wireless device 208 can receive beacons from the access devices 202B/202C.

When the wireless device 208 roams in the total WLAN coverage area provided by the system 200, the wireless device 208 can determine which device provides best access to the wireless device 208. For instance, the wireless device 208 repeatedly scans beacons of adjacent access devices and may be able to measure signal strength (e.g., power) related to each of the beacons. Hence, the wireless device 208 can be connected with an access device providing optimal network access based on maximum beacon signal strength. The wireless device 208 may be able to use a different reference related to optimal access. For instance, the optimal access may be associated with more preferable services (e.g., contents, data rate and the like).

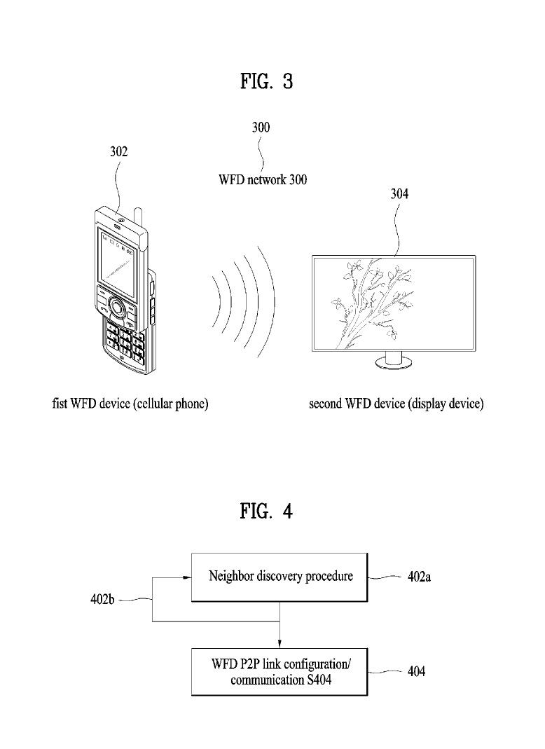

FIG. 3 is a diagram for an example of a WFD (Wi-Fi Direct) network.

A WFD network corresponds to a network capable of performing D2D (device-to-device) (or peer to peer (P2P) communication although Wi-Fi devices do not participate in a home network, an office network or a hot-spot network. The WFD network is proposed by Wi-Fi alliance. In the following, WFD-based communication is called WFD D2D communication (simply, D2D communication) or WFD P2P communication (simply, P2P communication). And, a device performing the WFD P2P communication is called a WFD P2P device, simply, a P2P device.

Referring to FIG. 3, a WFD network 300 can include at least one or more Wi-Fi devices including a first WFD device 302 and a second WFD device 304. A WFD device includes devices supporting Wi-Fi such as a display device, a printer, a digital camera, a projector, a smartphone and the like. And, the WFD device includes a non-AP STA and an AP STA. Referring to an example shown in the drawing, the first WFD device 302 corresponds to a smartphone and the second WFD device 304 corresponds to a display device. WFD devices in the WFD network can be directly connected with each other. Specifically, P2P communication may correspond to a case that a signal transmission path between two WFD devices is directly configured between the WFD devices without passing through a third device (e.g., an AP) or a legacy network (e.g., access WLAN via an AP). In this case, the signal transmission path directly configured between the two WFD devices may be restricted to a data transmission path. For instance, P2P communication may correspond to a case that a plurality of non-STAs transmit data (e.g., audio/image/text message information etc.) without passing through an AP. A signal transmission path for control information (e.g., resource allocation information for P2P configuration, wireless device identification information and the like) can be directly configured between WFD devices (e.g., between a non-AP STA and a non-AP STA, between a non-AP STA and an AP), between two WFD devices (e.g., between a non-AP STA and a non-AP STA) via an AP or between an AP and a corresponding WFD device (e.g., an AP and a non-AP STA #1, between an AP and a non-AP STA #2).

FIG. 4 is a flowchart for an example of a procedure of configuring a WFD network.

Referring to FIG. 4, a procedure of configuring a WFD network can be mainly divided into two procedures. A first procedure corresponds to a neighbor (device) discovery (ND) procedure [S402a] and a second procedure corresponds to a P2P link configuration and communication procedure [S404]. A WFD device (e.g., 302 in FIG. 3) finds out a different neighboring device (e.g., 304 in FIG. 3) in coverage (of the WFD device) via the neighbor discovery procedure and may be able to obtain information necessary for associating with the neighboring WFD device, e.g., information necessary for pre-association. In this case, the pre-association may indicate second layer pre-association in a wireless protocol. The information necessary for the pre-association can include identification information on the neighboring WFD device for example. The neighbor discovery procedure can be performed according to an available radio channel [S402b]. Subsequently, the WFD device 302 can perform a WFll P2P link configuration/communication procedure with the different WFD device 304. For instance, the WFD device 302 can determine whether the WFD device 304 corresponds to a WFD device not satisfying a service requirement of a user after the WFD device 302 is connected with the neighboring WFD device 304. To this end, the WFD device 302 is second layer pre-associated with the neighboring WFD device 304 and may be then able to search for the WFD device 304. If the WFD device 304 does not satisfy the service requirement of the user, the WFD device 302 disconnects the second layer connection established with the WFD device 304 and may be able to establish the second layer connection with a different WFD device. On the contrary, if the WFD device 304 satisfies the service requirement of the user, the two WFD devices 302/304 can transceive a signal with each other via a P2P link.

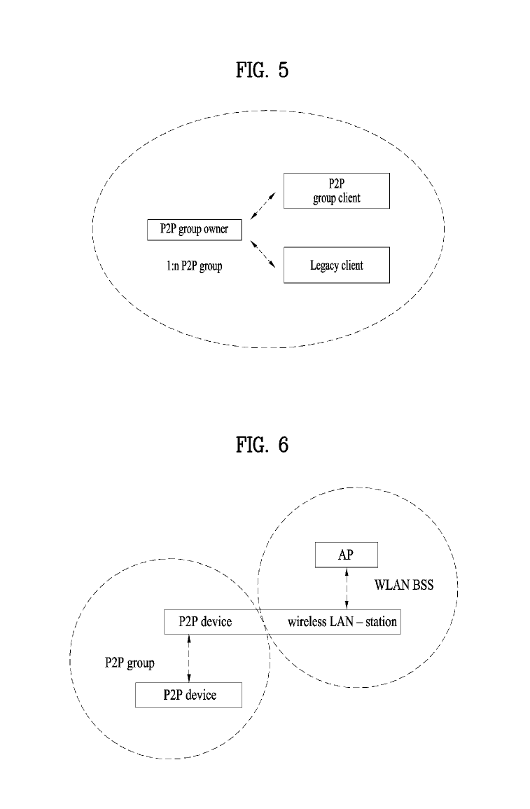

FIG. 5 is a diagram for a typical P2P network topology.

As shown in FIG. 5, a P2P GO can be directly connected with a client including a P2P function. Or, the P2P GO can be connected with a legacy client, which has no P2P function.

FIG. 6 is a diagram for a situation that a single P2P device forms a P2P group and is connected with an AP in a manner of operating as an STA of WLAN at the same time.

As shown in FIG. 6, according to P2P technical standard, a situation that a P2P device operates in the aforementioned mode is defined as a concurrent operation.

In order for a series of P2P devices to form a group, a P2P GO is determined based on a group owner intent value of a P2P attribute ID. The group owner intent value may have a value ranging from 0 to 15. P2P devices are exchanging the values and a P2P device including a highest value becomes the P2P GO. Meanwhile, in case of a legacy device not supporting the Wi-Fi P2P technology, although the legacy device can belong to a P2P group, a function of the legacy device is limited to a function of accessing an infrastructure network via the P2P GO.

According to Wi-Fi P2P standard, since a P2P GO transmits a beacon signal using OFDM (orthogonal frequency division multiplexing), a P2P device does not support 11b standard. Instead, 11a/g/n can be used as Wi-Fi P2P device.

In order to perform an operation of connecting a P2P GO and a P2P client with each other, a P2P standard mainly includes 4 functions described in the following.

First of all, P2P discovery is dealing with such a description entry as device discovery, service discovery, group formation and P2P invitation. According to the device discovery, 2 P2P devices exchange device-related information such as a device name of a counterpart device or a device type with each other via an identical channel According to the service discovery, a service to be used and service-related information are exchanged with each other via P2P. According to the group formation, it corresponds to a function that a device to be a P2P GO is determined and a new group is formed. According to the P2P invitation, it corresponds to a function that a permanently formed P2P group is summoned or a function of making a P2P device join a legacy P2P group.

Secondly, P2P group operation explains P2P group formation and termination, connection to a P2P group, communication in a P2P group, a service for P2P client discovery, operation of a persistent P2P group and the like.

Thirdly, P2P power management is dealing with a method of managing power of a P2P device and a method of processing a signal on power saving mode timing.

Lastly, managed P2P device is dealing with a method of forming a P2P group in a single P2P device and a method of accessing an infrastructure network via a WLAN AP at the same time.

Characteristics of a P2P group are explained in the following. A P2P group is similar to a legacy infrastructure BSS (basic service set) in that a P2P GO plays a role of an AP and a P2P client plays a role of an STA. Hence, software capable of performing a role of a GO and a role of a client should be mounted on a P2P device. The P2P device is distinguished by using a P2P device address such as a MAC address. Yet, when the P2P device performs communication in a P2P group, the P2P device uses a P2P interface address. In this case, it is not necessary for the P2P device to use a single identifier (a globally unique ID) address. The P2P group includes a single identifier P2P group ID. The single identifier P2P group ID consists of a combination of an SSID (service set identifier) and a P2P device address. Wi-Fi P2P standard uses WPA2-PSK/AES for security. A life cycle of a P2P group has a temporary connection method and a persistent connection method for attempting an identical connection after prescribed time. In case of a persistent group, once a P2P group is formed, a role, a certificate, an SSID and a P2P group ID are cached. When connection is reestablished, connection of a group can be promptly established by applying an identical connection form.

In the following, Wi-Fi P2P connection method is explained. A Wi-Fi device mainly performs a connection procedure of two phases. First one corresponds to a phase that two P2P devices find out a counterpart device and a second one corresponds to a group formation phase for determining a role of a P2P GO or a role of a P2P client between discovered devices. First of all, the finding phase corresponds to a phase of connecting P2P devices with each other. In particular, the finding phase includes a search state and a listen state. The search state performs active search using a probe request frame. In this case, a range of the search is restricted for a quick search. For the quick search, such a social channel as a channel 1, 6 and 11 are used. A P2P device of the listen state maintains a reception state in a manner of selecting one channel from the 3 social channels. If the P2P device receives a probe request frame transmitted by a different P2P device of the search state, the P2P device transmits a probe response frame to the different P2P device in response to the probe request frame. P2P devices continuously repeat the search state and the listen state and may be able to arrive at a channel common to the P2P devices. The P2P devices find out a counterpart device and use a probe request frame and a probe response frame to selectively combine with the counterpart device and to discover a device type, a manufacturer, or a friendly device name In order to check a service existing in the internal of the P2P devices and compatible between the devices, it may use the service discovery. The service discovery is used to determine whether a service provided in the internal of each device is compatible with a different device. According to the P2P standard, a specific service discovery standard is not designated. A user of a P2P device searches for a neighboring P2P device and a service provided by the P2P device and may be then able to connect with a device or a service preferred by the user.

As a second phase, a group formation phase is explained in the following. If a P2P device completes the aforementioned find phase, checking existence of a counterpart device is completed. Based on this, two P2P devices should enter a GO negotiation phase to configure a BSS. The negotiation phase is divided into two sub phases. One is a GO negotiation phase and another is a WPS (Wi-Fi protected setup) phase. In the GO negotiation phase, the two P2P devices negotiate a role of a P2P GO and a role of a P2P client with each other and an operation channel to be used in the internal of a P2P group is configured. In the WPS phase, such a usual job performed in a legacy WPS as exchanging PIN information inputted by a user using a keypad or the like, simple setup via a push button and the like is performed. In a P2P group, a P2P GO plays core role of the P2P group. The P2P GO assigns a P2P interface address, selects an operation channel of the group and transmits a beacon signal including various operation parameters of the group. In the P2P group, a beacon signal can be transmitted by the P2P GO only. A P2P device can quickly check the P2P GO using the beacon signal in a scan phase corresponding to a connection initial phase and performs a role of participating in the group. Or, the P2P GO can initiate a P2P group session by itself or may be able to initiate a session after the method mentioned earlier in the P2P finding phase is performed. Hence, since a value intended to be the P2P GO is controlled by an application or a higher layer service instead of a value fixed by a certain device, a developer can select an appropriate value, which is intended to be the P2P GO, according to a usage of each application program.

Subsequently, P2P addressing is explained in the following. A P2P device uses a P2P interface address in a manner of assigning a P2P interface address using a MAC address in a P2P group session. In this case, the P2P interface address of a P2P GO corresponds to a BSSID (BSS identifier). The BSSID practically corresponds to a MAC address of the P2P GO.

Connection release of a P2P group is explained in the following. If a P2P session is terminated, a P2P GO should inform all P2P clients of termination of a P2P group session via De-authentication. A P2P client can also inform the P2P GO of connection release. In this case, if possible, it is necessary to perform a disassociation procedure. Having received a connection release request of a client, the P2P GO can identify that connection of the P2P client is released. If the P2P GO detects a P2P client making a protocol error or performing an operation of interrupting connection of a P2P group, the P2P GO generates rejection of authentication or a denial of association. In this case, the P2P GO records a concrete failure reason on an association response and transmits the association response to the P2P client.

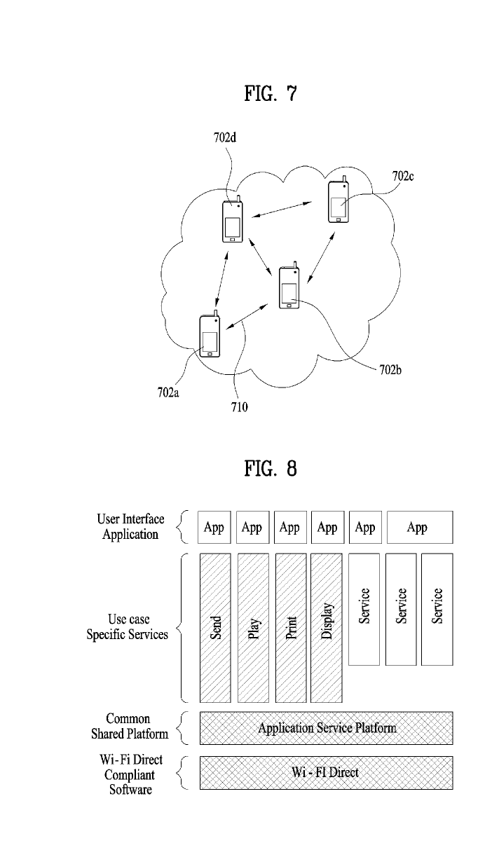

FIG. 7 is a diagram for a WFD network aspect in case that P2P is applied.

FIG. 7 shows an example of a WFD network aspect in case of applying a new P2P application (e.g., social chatting, location-based service provision, game interworking and the like). Referring to FIG. 7, a plurality of P2P devices 702a to 702d perform P2P communication 710 in a WFD network. P2P device(s) constructing the WFD network frequently change due to movement of the P2P device or the WFD network itself can be newly generated or disappeared dynamically/in a short time. Hence, characteristic of the new P2P application part is in that P2P communication can be performed and terminated dynamically/in a short time between a plurality of the P2P devices in dense network environment.

FIG. 8 is a simplified block diagram for a WI-DS (Wi-Fi Direct services) device.

A platform for such an application service as an ASP (application service platform) is defined for a Wi-Fi Direct MAC layer and above. The ASP plays a role of session management, command processing of a service, control between ASPs and security between a higher application and a lower Wi-Fi Direct. 4 basic services including a Send service, a Play service, a Display service and a Print service defined by WI-DS, a corresponding application and an UI (user interface) are supported at the top of the ASP. In this case, the Send service corresponds to a service capable of performing file transfer between two WFDS devices and an application therefor. The Play service corresponds to a streaming service capable of sharing A/V, a picture, and music based on a DLNA between two WFDS devices and an application therefor. The Print service defines a service capable of outputting a document and a picture between a device including contents such as a document, a picture and the like and a printer and an application therefor. The Display service defines a service enabling screen sharing between Miracast source of WFA and Miracast sink and an application therefor. And, an enablement service is defined for the use of an ASP common platform in case of supporting a third party application except a basic service.

Among terminologies described in the present invention, such a terminology as a service hash is formed from a service name using a first 6 octets of a service hash algorithm (e.g., SHA256 hashing) of a service name. A service hash used by the present invention does not mean a specific service hash. Instead, it may be preferable to comprehend the service hash as a sufficient representation of a service name using a probe request/response discovery mechanism. As a simple example, if a service name corresponds to “org.wifi.example”, 6 bytes of a forepart of a value of which the service name is hashed by the SHA256 corresponds to a hash value.

In WFDS, if a hash value is included in a probe request message and a service is matched with each other, it may be able to check whether the service is supported in a manner of responding by a probe response message including a service name. In particular, the service name corresponds to a name of a user readable service of a DNS form. A service hash value indicates upper 6 bytes among a value of 256 bytes of the service name generated by an algorithm (e.g., SHA256). As mentioned in the foregoing example, if a service name corresponds to “org.wifi.example”, a service hash may correspond to a value of “4e-ce-7e-64-39-49”.

Hence, a part of a value of which a service name is hashed by an algorithm is represented as a service hash (information) in the present invention. The service hash can be included in a message as information.

Method of Configuring Legacy WFDS

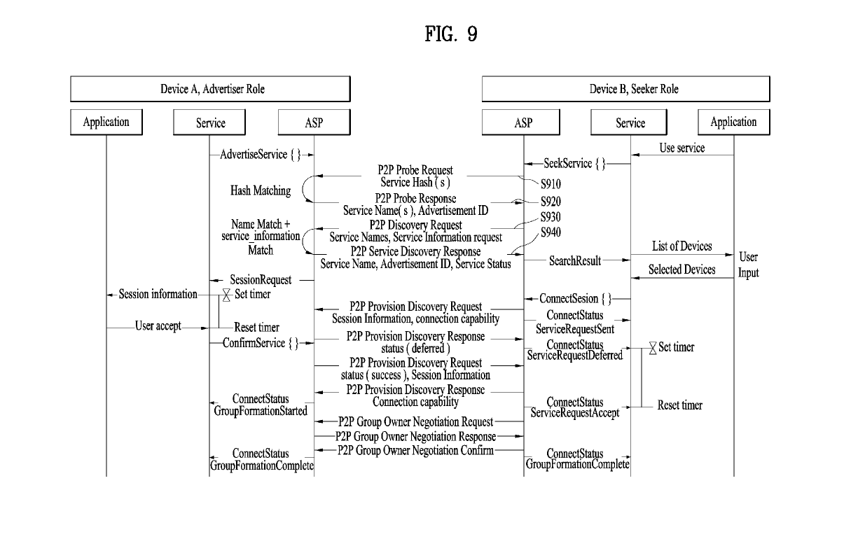

FIG. 9 is a flowchart for a process of establishing a WFDS session by discovering a device and a service between WFDS devices in a legacy WI-DS.

For clarity, as shown in FIG. 4, assume that a device A plays a role of an advertiser advertising a WFDS capable of being provided by the device A to a seeker and a device B plays a role in seeking an advertised service. The device A corresponds to a device intending to advertise a service of the device A and a counterpart device intends to start the service in a manner of finding out the service of the device A. The device B performs a procedure of finding out a device supporting a service according to a request of a higher application or a user.

A service end of the device A advertises a WFDS capable of being provided by the service end to an application service platform (ASP) end of the device A. A service end of the device B can also advertise a WFDS capable of being provided by the service end to an ASP end of the device B. In order for the device B to use a WFDS as a seeker, an application end of the device B indicates a service to be used to the service end and the service end indicates the ASP end to find out a target device to use the WFDS.

In order to find out the target device to use the WFDS, the ASP end of the device B transmits a P2P (peer to peer) probe request message [S910]. In this case, the P2P probe request message includes a service name, which is intended to be found out by the ASP end of the device B or is capable of being supported by the ASP end of the device B, in a service hash form in a manner of hashing the service name Having received the P2P probe request message from the seeker, if the device A supports the corresponding service, the device A transmits a P2P probe response message to the device B in response to the P2P probe request message [S920]. The P2P probe response message includes a service supported by a service name or a hash value and a corresponding advertise ID value. This procedure corresponds to a device discovery procedure indicating that the device A and the device B are WFDS devices. It is able to know whether a service is supported via the device discovery procedure.

Subsequently, it is able to know a specific service in detail via a P2P service discovery procedure, optionally. The device B, which has found a device capable of performing a WI-DS with the device B, transmits a P2P service discovery request message to the device [S930]. Having received the P2P service discovery request message from the device B, the ASP end of the device A transmits a P2P service discovery response message to the device B in a manner of matching the service advertised by the service end of the device A with a P2P service name and a P2P service information received from the device B with each other [S940]. In this case, a GAS protocol defined by IEEE 802.11u is used. As mentioned in the foregoing description, when a request for a service search is completed, the device B can inform an application and a user of a search result. At this point, a group of Wi-Fi Direct is not formed yet. If a user selects a service and the selected service performs a connect session, P2P group formation is performed.

In the following, a method of configuring an ASP operating based on at least one selected from the group consisting of WFA, WFDS, Wi-Fi Direct, NAN (Neighbor Awareness Networking), NFC (Near Field Communication), and BLE(Bluetooth Low Energy) is disclosed as an embodiment of the present invention. In this case, the WFDS and the like may correspond to an interface. In particular, the interface may correspond to a method of supporting an operation of a device. In the following, a method for an ASP to interwork with a device/service discovery based on the interfaces is explained in detail.

In this case, for example, among the aforementioned interfaces, the BLE may correspond to a Bluetooth transmission/reception scheme in a form of using a frequency of 2.4 GHz and reducing power consumption. In particular, in order to quickly transmit and receive data of extremely small capacity, it may use the BLE to transmit data while reducing power consumption.

And, for example, the NAN (neighbor awareness networking) network may correspond to NAN devices using a set of the same NAN parameters (e.g., a time period between continuous discovery windows, a period of a discovery window, a beacon interval, a NAN channel, etc.). The NAN devices can configure a NAN cluster. In this case, the NAN cluster uses a set of the same NAN parameters and may correspond to a set of NAN devices synchronized with the same window schedule. A NAN device belonging to the NAN cluster can directly transmit a multicast/unicast NAN service discovery frame to a different NAN device within a range of a discovery window.

And, for example, the NFC may operate on a relatively low frequency band such as 13.56 MHz. In this case, if two P2P devices support the NFC, it may optionally use an NFC channel A seeker P2P device can discover a P2P device using the NFC channel When an NFC device is discovered, it may indicate that two P2P devices agree on a common channel for forming a group and share provisioning information such as a password of a device.

A method of interworking via an ASP for the aforementioned interfaces is explained in detail in the following. In this case, although the abovementioned configurations are proposed as an interface capable of being interlocked with the ASP, this is an example only. It may support a different interface as well, by which the present invention may be non-limited.

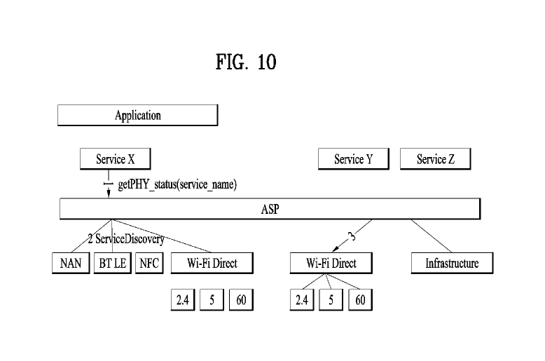

FIG. 10 is a diagram for a service application platform (ASP) supporting a plurality of interfaces.

As mentioned in the foregoing description, a service end of an advertiser device corresponding to a device supporting WFDS advertises a service capable of being provided by the service end and a service end of a seeker device corresponding to a different device supporting the WFDS can indicate an ASP end to search for a target device for which the service is to be used. In particular, it may be able to support the WFDS between devices via the ASP.

In this case, referring to FIG. 10, the ASP can support a plurality of interfaces. In this case, for example, the ASP can support a plurality of interfaces for performing service discovery. And, the ASP can support a plurality of interfaces for performing service connection.

In this case, for example, a plurality of the interfaces for performing the service discovery may correspond to at least one selected from the group consisting of Wi-Fi Direct, NAN (Neighbor Awareness Networking), NFC (Near Field Communication), BLE (Bluetooth Low Energy), and WLAN Infrastructure.

And, a plurality of the interfaces for performing the service connection may correspond to at least one selected from the group consisting of Wi-Pi Direct, P2P, and Infrastructure. And, for example, the ASP can support a plurality of frequency bands. In this case, for example, a plurality of the frequency bands may correspond to 2.4 GHz, 5 GHz, 60 GHz, and the like. And, for example, the ASP can support information on a frequency band less than 1 GHz. In particular, the ASP can support a plurality of frequency band and is not restricted to a specific frequency band.

Referring to FIG. 10, a first device can perform device discovery or service discovery on a first service using the ASP. Subsequently, if searching for the device discovery or the service discovery is completed, it may perform service connection based on a search result. In this case, for example, an interface used for performing the service discovery may be different from an interface used for performing the service connection. The interfaces can be selected from among a plurality of interfaces.

In this case, the ASP may use information or a parameter for supporting a plurality of the interfaces.

Regarding the ASP, for example, a service end of a device can obtain information on a service discovery method capable of supporting the first service and a connection method from the ASP. In this case, the first service may correspond to a service provided by the device and is not restricted to a specific service.

The service end of the device can call AdvertiseService( ) or SeekService( ) method to the ASP based on the information obtained from the ASP. In particular, similar to a legacy ASP operation, the device can use the ASP as an advertiser or a seeker to perform service discovery on the first service. After the service discovery is performed on the first service, the device can perform service connection based on a result of the service discovery. In this case, the service connection may correspond to a P2P or a WLAN infrastructure. In this case, for example, since both the service connections support a plurality of frequency bands, the service connection can be performed on the basis of a preferred band.

More specifically, referring to FIG. 10, the service end of the device can transmit a message for a service to be used by the device to the ASP by calling getPHY_status(service_name) method. In this case, the service end receives a return value from the ASP and may be able to obtain information on a plurality of frequency bands for a service discovery method and a service connection method supported by the ASP. By doing so, the device informs the ASP of information on a preferred connection method for a service and a preferred frequency band for the service and the device can obtain information on a service discovery method and a service connection method supported by the ASP. The ASP performs service discovery based on the information received from the service end, searches for a specific device, and connects the specific device with the ASP to use a service.

In this case, for example, information described in Table 1 can be included in the aforementioned getPHY_status (service_name). In this case, Table 1 includes information on an upper concept at the left of Table 1 and includes information on a lower concept at the right of Table 1.

TABLE 1

| Connectivity | P2P [symbol] | Multiband | 2.4, 5, 60 GHz [symbol] | |
|---|---|---|---|---|
| methods [symbol] | | information [symbol] | | |
| | Infrastructure [symbol] | BSSID [symbol] | | |
| | information [symbol] | Multiband | 2.4, 5, 60 GHz [symbol] | Channel Index |
| | | information [symbol] | | per band [symbol] |

| Service | NAN [symbol] | | |
|---|---|---|---|
| Discovery | BTLE [symbol] | | |
| methods [symbol] | NFC [symbol] | | |
| | Infrastructure [symbol] | | |
| | P2P [symbol] | Multiband | 2.4, 5, 60 GHz [symbol] |
| | | information [symbol] | |

As mentioned in the foregoing description, the device can search for neighboring devices via the neighbor discovery procedure, the P2P link configuration, and the communication procedure. And, the device can discover a neighbor device for a service using the ASP as a higher layer of Wi-Fi Direct MAC layer. And, the device can discover a neighbor device for a service using the ASP supporting a plurality of interfaces. In particular, when the device searches for a different device for a service, a searching procedure can be performed via a different method/procedure.

In the following, if a device discovers a neighbor device for a service using ASP supporting a plurality of interfaces, it is referred to as a first type. In this case, a first type device may correspond to a WFD R2 device.

And, if a device discovers a neighbor device via a neighbor device discovery procedure and P2P link configuration without the support of the ASP as a WFD network configuration, it is referred to as a second type. In this case, a second type device may correspond to a WFD R1 device.

And, if a device discovers a neighbor device for a service using the ASP as a higher layer of Wi-Fi Direct MAC layer, it is referred to as a third type. In this case, a third type device may correspond to a WFDS display service device.

In the following, a method for a device supporting a first type (hereinafter, a first type device) to perform service discovery with a second type device and a third type device is explained.

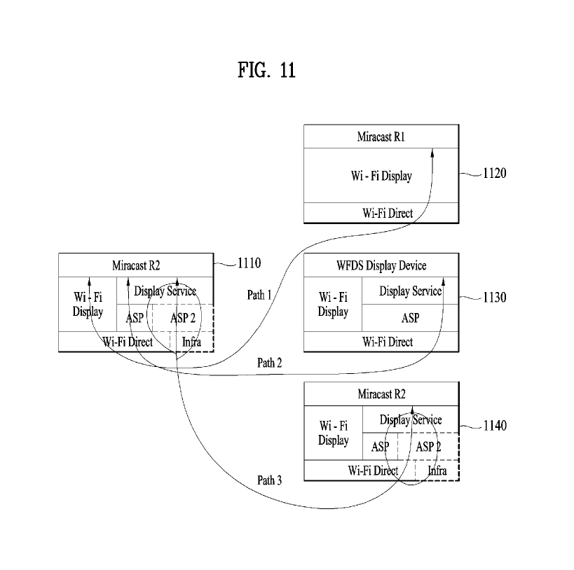

FIG. 11 is a diagram of a method for a first type device to perform service discovery with at least one device selected from the group consisting of a different first type device, a second type device, and a third type device.

In this case, for example, the first type device corresponds to a seeker device 1110 and can search for other devices. In particular, the first type seeker device 1110 can search for an advertiser of the same type or a different type. In this case, for example, if the first type seeker device 1110 search for a first type advertiser device 1140 and performs service discovery, the first type seeker device 1110 and the first type advertiser device 1140 can perform service discovery using ASP supporting a plurality of interfaces. In particular, the first type seeker device 1110 and the first type advertiser device 1140 can perform service discovery using the ASP mentioned earlier in FIG. 10. In particular, the first type seeker device 1110 and the first type advertiser device 1140 can use a specific interface among a plurality of the interfaces for a service discovery procedure.

And, the first type seeker device 1110 can perform service discovery with a second type advertiser device 1120. In this case, the second type advertiser device 1120 may correspond to a device performing P2P connection via a neighbor device discovery procedure while not supporting ASP. In particular, the first type seeker device 1110 and the second type advertiser device 1120 can search for a neighbor device based on Wi-Fi Direct interface. In this case, for example, the first type seeker device 1110 and the second type advertiser device 1120 can search for a neighbor device only without specifying a service, by which the present invention may be non-limited.

And, for example, the first type seeker device 1110 can perform service discovery with a third type advertiser device 1130. In this case, the third type advertiser device 1130 may correspond to an ASP supporting device that performs discovery using Wi-Fi Direct. In particular, the ASP supported by the third type advertiser device 1130 may correspond to a device supporting the Wi-Fi Direct interface only rather than a device supporting a plurality of interfaces. In this case, for example, the first type seeker device 1110 and the third type advertiser device 1130 can perform service discovery using the ASP. In this case, the service discovery performed by the first type seeker device 1110 and the third type advertiser device 1130 can be performed based on the Wi-Fi Direct interface.

As a different example, an advertiser device corresponding to the first type device can perform service discovery with a seeker device of the same type or a different type. In particular, a first type advertiser device 1110 can perform service discovery with at least one selected from the group consisting of a first type seeker device 1140, a second type seeker device 1120, and a third type seeker device 1130.

In this case, for example, if the first type advertiser device 1110 searches for the first type seeker device 1140 and performs service discovery, the first type advertiser device 1110 and the first type seeker device 1140 can perform service discovery using ASP supporting a plurality of interfaces. In particular, the first type advertiser device 1110 and the first type seeker device 1140 can perform service discovery using the ASP mentioned earlier in FIG. 10. In particular, the first type advertiser device 1110 and the first type seeker device 1140 can use a specific interface among a plurality of the interfaces for a service discovery procedure.

And, the first type advertiser device 1110 can perform service discovery with a second type seeker device 1120. In this case, the second type seeker device 1120 may correspond to a device performing P2P connection via a neighbor device discovery procedure while not supporting ASP. In particular, the first type advertiser device 1110 and the second type seeker device 1120 can search for a neighbor device based on Wi-Fi Direct interface. In this case, for example, the first type advertiser device 1110 and the second type seeker device 1120 can search for a neighbor device only without specifying a service, by which the present invention may be non-limited.

And, for example, the first type advertiser device 1110 can perform service discovery with a third type seeker device 1130. In this case, the third type seeker device 1130 may correspond to an ASP supporting device that performs discovery using Wi-Fi Direct. In particular, the ASP supported by the third type seeker device 1130 may correspond to a device supporting the Wi-Fi Direct interface only rather than a device supporting a plurality of interfaces. In this case, for example, the first type advertiser device 1110 and the third type seeker device 1130 can perform service discovery using the ASP. In this case, the service discovery performed by the first type advertiser device 1110 and the third type seeker device 1130 can be performed based on the Wi-Fi Direct interface.

As a further different example, it may perform service discovery in environment in which a first type device and a second type device exist only. In particular, a first type seeker device can perform service discovery with at least one of a first type advertiser device and a second type advertiser device. And, the first type advertiser device can perform service discovery with at least one of a first type seeker device and a second type seeker device. In particular, when a device supports ASP according to a device type, the ASP may operate based on a plurality of interfaces. And, a device not supporting ASP may exist according to a device type.

As mentioned in the foregoing description, a device type may vary. In the following, a method for a device to perform service discovery is described in consideration of backward compatibility for a device of a different type.

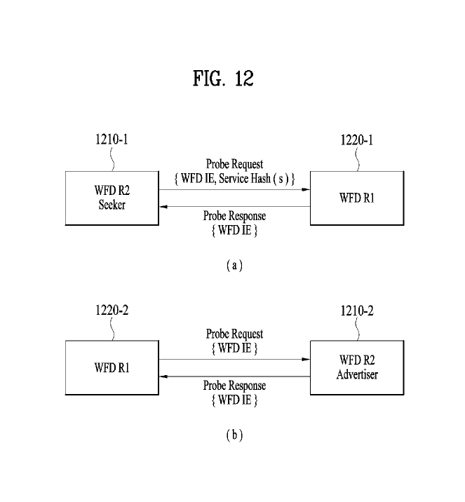

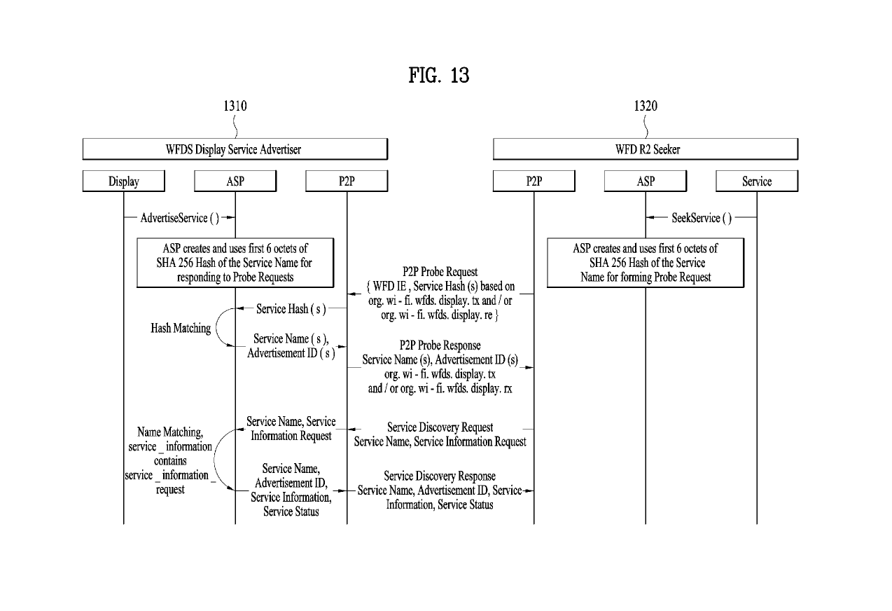

FIG. 12 is a diagram of a method for a first type device and a second type device to perform service discovery.

A first type seeker device 1210-1 can transmit a probe request message to an advertiser device 1220-1 to perform service discovery. In this case, for example, the first type seeker device 1210-1 can transmit the probe request message via broadcasting or multicasting. In particular, the first type seeker device 1210-1 can transmit the probe request message to a plurality of advertiser devices. In this case, for example, a plurality of the advertiser devices may correspond to devices of a different type.

In this case, for example, the probe request message transmitted by the first type seeker device 1210-1 can include service hash and WFD IE (Wi-Fi Display Information Element). In this case, for example, the probe request message can include multiple service hash. In this case, first type identification information can be included in the service hash. The first type identification information may correspond to identification information used for the first type seeker device and a first type advertiser device to perform service discovery. And, third type identification information can be included in the service hash. The third type identification information may correspond to identification information used for the first type seeker device and a third type advertiser device to perform service discovery.

And, the WFD IE included in the probe request message may correspond to second type identification information. In this case, the first type seeker device can perform service discovery with a second type advertiser device using the second type identification information.

In particular, the first type seeker device 1210-1 is unable to know all types of advertiser devices in environment in which advertiser devices of a plurality of types are mixed. Hence, the first type seeker device 1210-1 can include the service hash for the first type identification information and the third type identification information and the WFD IR for the second type identification information in the probe request message transmitted via broadcasting or multicasting. By doing so, the first type seeker device 1210-1 can support advertiser devices for a plurality of types and service discovery.

And, for example, the probe request message can include the service hash and the WFD IE as the first type identification information and the second type identification information, respectively, by which the present invention may be non-limited.

Referring to FIG. 12 (a), a second type advertiser device 1220-1 can receive the probe request message transmitted by the first type seeker device 1210-1. In this case, the second type advertiser device 1220-1 can transmit a probe response message to the first type seeker device 1210-1 in response to the probe request message. In this case, as mentioned in the foregoing description, the second type advertiser device 1220-1 may correspond to an advertiser device that discovers a neighbor device using Wi-Fi Direct without the support of ASP. In this case, the first type seeker device 1210-1 and the second type advertiser device 1220-1 can perform service discovery using the WFD IE as second type identification information. Hence, the second type advertiser device 1220-1 can transmit the probe response message to the first type seeker device 1210-1 by including the WFD IE in the probe response message.

In this case, for example, the WFD IE is included only in the probe response message and the service hash may not be included in the probe response message. Having received the probe response message, since the WFD IE is included in the probe response message, the first type seeker device 1210-1 can determine that an advertiser device corresponds to the second type advertiser device 1220-1. Subsequently, the first type seeker device 1210-1 can perform service discovery with the second type advertiser device 1220-1.

As a different example, referring to FIG. 12(b), the first type advertiser device 1210-2 can receive a probe request message transmitted by a seeker device. In this case, the first type advertiser device 1210-2 is able to know a type of the seeker device via the probe request message.

More specifically, if the seeker device corresponds to a second type seeker device 1220-1, WFD IE can be included in the probe request message only. In this case, if the first type advertiser device 1210-2 receives the probe request message including the WFD IE only, the first type advertiser device 1210-2 can determine that the seeker device corresponds to the second type seeker device 1220-2. In this case, the first type advertiser device 1210-2 can transmit a probe response message to the second type seeker device 1220-2 in a manner of including the WFD IE in the probe response message only. Subsequently, the first type advertiser device 1210-2 and the second type seeker device 1220-2 can perform service discovery using the WFD IE.

In this case, for example, if a seeker device corresponds to a first type seeker device, as mentioned in the foregoing description, WFD IE and service hash can be included in a probe request message. In this case, the first type advertiser device 1210-2 can transmit a probe response message to the first type seeker device in a manner of including service hash in a probe response message. Regarding this, it shall be described later.

In this case, for example, the WFD IE is shown in Table 2 in the following. In particular, the WFD IE included in the probe request message can include at least one field selected from the group consisting of an element ID field, a length field, an OUI field, an OUI type filed, and a WFD subelements field.

TABLE 2

| | | Value | |
|---|---|---|---|
| | Size | (Hexa- | |
| Field | (octets) | decimal) | Description |
| Element | 1 | DD | IEEE 802.11 vendor specific usage |
| ID | | | |
| Length | 1 | Vari- | Length of the following fields in the |
| | | able | IE in octets. The length field is |
| | | | variable and set to 4 plus the total |
| | | | length of WFD subelements. |
| OUI | 3 | 50-6F-9A | WFA Specific OUI |
| OUI | 1 | 0A | Identifying the type or version of the |
| Type | | | WFD IE. Setting to 0x0A indicates |
| | | | WFA WFD v1.0 |
| WFD sub- | Vari- | | One or more WFD subelements appear |
| elements | able | | in the WFD IE |

The WFD subelements field included in the WFD IE is shown Table 3 in the following. In particular, the WFD subelements field can include at least one field selected from the group consisting of a subelement ID field, a length field, and a subelement body field. In this case, the subelement body field is shown in Table 4 in the following. In particular, the subelement body field can include information on a WFD device. By doing so, a first type device and a second type device can perform discovery as neighbor devices and can perform service discovery using the information described in the following.

And, for example, the WFD IE, which is included in a probe request message and a probe response message exchanged between the first type seeker device and a second type advertiser device, may not include information on a first type device. In particular, information on a WFD device included in the subelement body field may include information on second type devices only. Information on first type devices may not be included in the subelement body field. By doing so, when a first type device determines a second type device, it may be able to prevent an error.

TABLE 3

| | | Value | |
|---|---|---|---|
| | Size | (Hexa- | |
| Field | (octets) | decimal) | Description |
| Subelement | 1 | | Identifying the type of WFD |
| ID | | | subelement. The specific value |
| | | | is defined in Table 5-3. |
| Length | 2 | Vari- | Length of the following fields |
| | | able | in the subelement |
| Subelements | Vari- | | Subelement specific information |
| body field | able | | fields |

TABLE 4

| | Size | | |
|---|---|---|---|
| Field | (octets) | Value | Description |
| Subelement | 1 | 0 | Identifying the type of WFD subelement. |
| ID | | | The specific value is defined in Table |
| | | | 5-3. |
| Length | 2 | 6 | Length of the following fields of the |
| | | | subelement. |
| WFD Device | 2 | | Bitmap defined in Table 5-5 detailing |
| Information | | | WFD Device Information. |
| Session | 2 | Valid | Default 7236 [33]. TCP port at which |
| Management | | TCP | the WFD Device listens for RTSP |
| Control Port | | port | messages. (If a WFD Sink that is |
| | | | transmitting this subelement does not |
| | | | support the RTSP server function, this |
| | | | field is set to all zeros.) The WFD |
| | | | Device can choose any value other |
| | | | than default 7236⁶. |
| WFD Device | 2 | | Maximum average throughput capability |
| Maximum | | | of the WFD Device represented in |
| Throughput | | | multiples of 1 Mbps |

FIG. 13 is a diagram of a method for a first type seeker device to perform service discovery with a third type advertiser device.

As mentioned in the foregoing description, a third type device corresponds to a device supporting ASP and may correspond to a device performing service discovery using Wi-Fi Direct interface. In this case, for example, the third type device may correspond to the aforementioned WFDS display service device. In this case, for example, a device may correspond to a source device, a sink device, and a dual-role device. In this case, the source device may correspond to a device supporting streaming of content. And, the sink device may correspond to a device receiving content streaming from the source device and performing rendering. And, the dual-role device may correspond to a device performing roles of the source device and the sink device. In this case, for example, the source device, the sink device, and the dual-role device may become the aforementioned seeker device or the advertiser device.

In this case, for example, the source device or the dual-role device can perform session connection with a WI-DS display service device (third type device) having a qualification of WFDS display service Rx. And, for example, the sink device or the dual-role device can perform session connection with a WFDS display service device (third type device) having a qualification of WFDS display service Tx.

In this case, for example, the first type seeker device can include a plurality of service hashes in the probe request message. For example, if the first type seeker device corresponds to a source device, as mentioned in the foregoing description, it is necessary for the first type seeker device to search for a device having a qualification of WI-DS display service Rx. Hence, the first type seeker device can transmit the probe request message in a manner of including a service hash calculated by “org.wi-fi.wfds.display.rx” in the probe request message.

And, for example, if the first type seeker device corresponds to a sink device, as mentioned in the foregoing description, it is necessary for the first type seeker device to search for a device having a qualification of WFDS display service Tx. Hence, the first type seeker device can transmit the probe request message in a manner of including a service hash calculated by “org.wi-fi.wfds.display.tx” in the probe request message.

And, for example, if the first type seeker device corresponds to a dual-role device, it is necessary for the first type seeker device to search for a device having a qualification of WFDS display service Rx and a device having a qualification of WFDS display service Tx. Hence, the first type seeker device can transmit the probe request message in a manner of including all service hashes calculated by “org.wi-fi.wfds.display.rx” and “org.wi-fi.wfds.display.tx” in the probe request message. In particular, the first type seeker device can include information of a plurality of hashes according to a type (source device, sink device, or dual-role device) of the first type seeker device.

In this case, referring to FIG. 13, a service/application end of a first type seeker device 1320 calls SeekService method to generate a service hash to be included in a probe request message. In this case, as mentioned in the foregoing description, it may be able to generate a plurality of service hashes in consideration of a type (source device, sink device, or dual-role device) of the first type seeker device. In this case, the first type seeker device can transmit the probe request message to a third type device 1310. In this case, the probe request message can include WFD IE and a service hash. In this case, the third type device 1310 can transmit a probe response message to the first type seeker device 1320. In this case, the probe response message can include a service name and an advertisement ID. In this case, the service name and the advertisement ID may correspond to values generated by the aforementioned service hash. And, the first type seeker device 1320 can transmit a service discovery request message to the third type advertiser device 1310. In this case, the service discovery request message can include a service name and a service information request. In this case, for example, a service information request parameter can include a different value based on the service name included in the probe response message. In this case, for example, the service name included in the probe response message may have such a value as “Display”, “Null”, or “display_capability” according to a service value calculated by “org.wi-fi.wfds.display.tx” and/or “org.wi-fi.wfds.display.rx”, by which the present invention may be non-limited. In particular, the first type seeker device 1320 receives the probe response message and may be able to transmit the service discovery request message to the third type advertiser device 1310. In this case, the service discovery request message can include a service name and a service information request. And, the third type advertiser device 1310 can transmit a service discovery response message to the first type seeker device 1320 based on the service discovery request message. In this case, for example, the service discovery response message can also include at least one selected from the group consisting of a service name, advertisement ID service information, and a service state, by which the present invention may be non-limited. By doing so, the first type seeker device 1320 can perform service discovery with the third type advertiser device 1310.

As a further different example, the third type seeker device can search for an advertiser device to perform service discovery. In this case, as mentioned in the foregoing description, a probe request message transmitted by the third type seeker device can include WFD IE and service hash. In this case, for example, a service hash value calculated by “org.wi-fi.wfds.display.tx” and/or “org.wi-fi.wfds.display.rx” can be included in the probe request message as service has for the third typw seeker device. In particular, the service hash value included in the probe request message may vary according to a type (source device, sink device, or dual-role device) of a device. In this case, if the advertiser device corresponds to a first type advertiser device, the first type advertiser device can transmit a probe response message to the third type seeker device in a manner of including a matched service name and an advertisement ID in the probe response message based on the aforementioned service hash value. In this case, the probe response message may not include WFD IE. Subsequently, as mentioned in the foregoing description, service discovery request/response message can be exchanged.

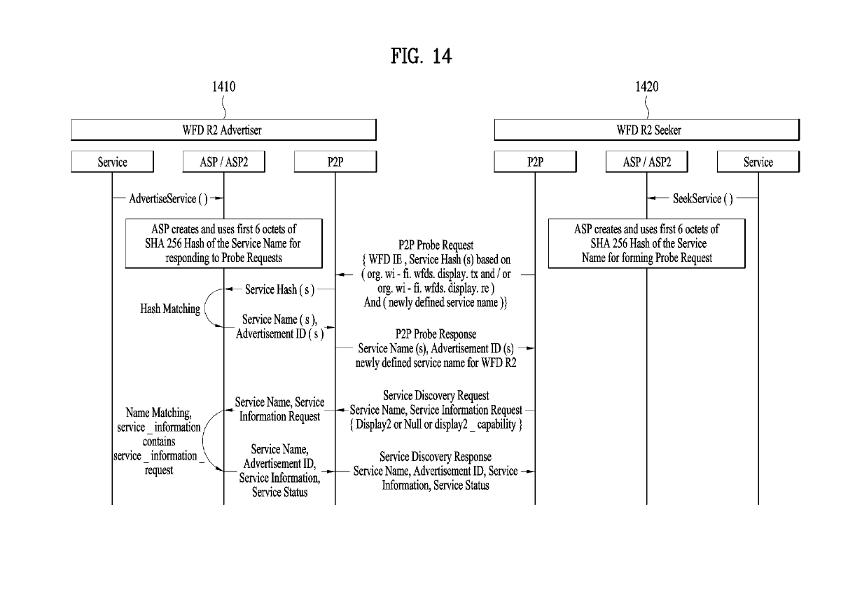

FIG. 14 is a diagram of a method for a first type seeker device and a first type advertiser device to perform service discovery.

The first type seeker device can transmit a probe request message including WFD IE and a plurality of service hashes via broadcasting or multicasting. In this case, for example, the service hashes included in the probe request message can include both a service hash for the aforementioned third type device and a service hash for the first type device. In particular, the probe request message transmitted by the first type seeker device can include the service hash for the third type device and the service hash for the first type device for the backward compatibility with the third type device.

In this case, for example, if the first type seeker device corresponds to a source device, the probe request message can include a service hash value calculated based on at least one of “_display._tcp” and “_displayssink._tcp” to search for a sink device as a first type advertiser device. And, for example, if the first type seeker device corresponds to a sink device, the probe request message can include a service hash value calculated based on “_displaysrc._tcp” to search for a source device as a first type advertiser device. And, for example, if the first type seeker device corresponds to a dual-role device, the probe request message can include a service hash value calculated based on at least one selected from the group consisting of “_display._tcp”, “_displayssink._tcp”, and “_displaysrc. _tcp”. In particular, the probe request message can include a plurality of service hash values.

In this case, for example, referring to FIG. 14, a service/application end of the first type seeker device 1420 can generate a service hash to be included in the probe request message by calling SeekService Method. In this case, as mentioned in the foregoing description, it may be able to generate a plurality of service hashes in consideration of a source device, a sink device, and a dual-role device. In this case, as mentioned in the foregoing description, it may be able to include a plurality of the service hashes including a service hash for the third type device and a service hash for the first type device.

In this case, the first type seeker device 1420 can transmit a probe request message to the first type device 1410. In this case, the probe request message can include WFD IE and a service hash. In this case, the first type device 1410 can transmit a probe response message to the first type seeker device 1420. In this case, the probe response message can include a service name and an advertisement ID. In this case, as mentioned in the foregoing description, the service name and the advertisement ID may correspond to values generated based on the service hash for the first type device. And, the first type seeker device 1420 can transmit a service discovery request message to the first type advertiser device 1410. In this case, the service discovery request message can include a service name and a service information request. In this case, the service information request parameter can include a different value based on the service name included in the probe response frame. In this case, for example, the probe response message may have a value such as “Display2”, “Null”, or “display2_capability”, by which the present invention may be non-limited. In this case, for example, the “Display2” may indicate that a seeker device requires information on all first type advertiser devices. And, for example, the “Null” may indicate that the seeker device does not require information on a first type advertiser device. And, the “display2_capability” may indicate that the seeker device requires information on a specific first type advertiser device or a third type advertiser device. In particular, the first type seeker device 1420 receives the probe response frame and may be then able to transmit the service discovery request message to the first type advertiser device 1410. In this case, the service discovery request message can include a service name and a service information request. The first type advertiser device 1410 can transmit a service discovery response message to the first type seeker device 1420 based on the service discovery request message. In this case, the service discovery response message can include at least one selected from the group consisting of a service name, an advertisement ID, and a service status, by which the present invention may be non-limited. By doing so, the first type seeker device 1420 can perform service discovery with the first type advertiser device 1410.

In this case, for example, when the first type seeker device and the first type advertiser device perform the service discovery, as mentioned in the foregoing description, it may use NAN, BLE, NFC, and the like as a plurality of interfaces.

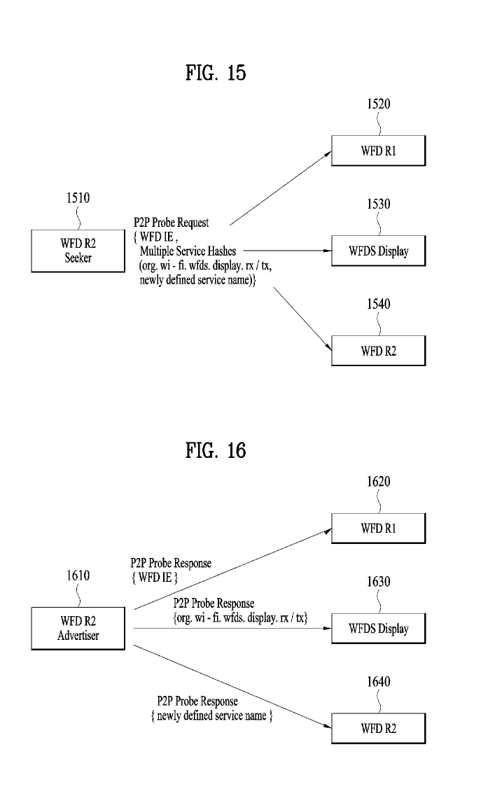

FIG. 15 is a diagram of a method for a first type seeker device to perform service discovery with an advertiser device. FIG. 16 is a diagram of a method for a first type advertiser device to perform service discovery with a seeker device.

Referring to FIG. 15, a first type seeker device 1510 can broadcast or multicast a probe request message. In this case, a plurality of advertiser devices 1520/1530/1540 can receive the probe request message transmitted by the first type seeker device 1510. In this case, for example, the probe request message can include WFD IE and a plurality of service hashes. In this case, a plurality of the service hashes can include first type identification information corresponding to identification information on a first type device and third type identification information corresponding to identification information on a third type device. And, the WFD IE may correspond to second type identification information corresponding to identification information on a second type device. In particular, the probe request message can be transmitted in a manner of including identification information on all device types in the probe request message. In this case, an advertiser device can perform service discovery with the first type seeker device 1510 using identification information matched with a type of the advertiser device among the identification information included in the probe request information.

Referring to FIG. 16, a first type advertiser device 1610 can receive a probe request message. In this case, for example, the first type advertiser device 1610 can determine a type of a seeker device based on identification information included in the probe request message. In this case, if a service hash value is included in the probe request message as first type identification information, the first type advertiser device 1610 can determine a seeker device as a first type seeker device. In this case, the first type advertiser device 1610 can transmit a probe response message including at least one of a service name and an advertisement ID, which are generated based on the service hash value, to a first type seeker device 1640 as the first type identification information. In this case, for example, the probe response message may not include WFD IE.

In this case, if the WFD IE is included in the probe request message as second type identification information, the first type advertiser device 1610 can determine a seeker device as a second type seeker device. In this case, the first type advertiser device 1610 can transmit a probe response message including the WFD IE to the second type seeker device 1620 as second type identification information. In this case, for example, the probe response message may not include the service name and the advertisement ID, which are generated based on the service hash.

In this case, if the service hash value is included in the probe request message as second type identification information, the first type advertiser device 1610 can determine a seeker device as a third type seeker device. In this case, the first type advertiser device 1610 can transmit a probe response message including at least one of a service name and an advertisement ID, which are generated based on the service hash value, to the third type seeker device 1620 as third type identification information. In this case, for example, the probe response message may not include WFD IE.

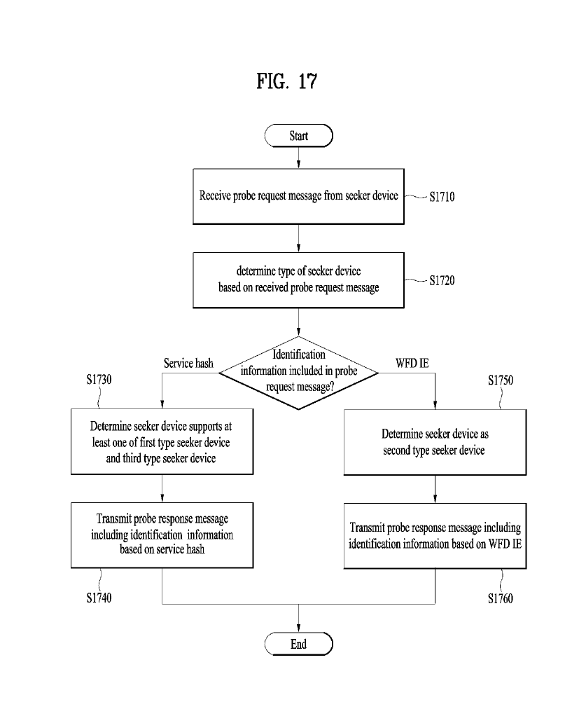

FIG. 17 is a flowchart of a method for a device to support a service using an application service platform according to one embodiment of the present specification.

A first type advertiser device can receive a probe request message from a seeker device [S1710]. Subsequently, the first type advertiser device can determine a type of the seeker device based on the received probe request message [S1720]. In this case, as mentioned earlier in FIGS. 11 to 16, the probe request message can include WFD IE or identification information as a service hash.

In this case, if the service hash is included in the probe request message, it can be determined as the seeker device supports at least one of a first type seeker device and a third type seeker device [S1730]. Subsequently, the first type advertiser device can transmit a probe response message including identification information based on the service hash [S1740]. In this case, as mentioned earlier in FIGS. 11 to 16, the first type advertiser device and the first type seeker device can perform service discovery using first type identification information based on a service hash. And, the first type advertiser device and the third type seeker device can perform service discovery using third type identification information based on a service hash.

In this case, a plurality of service hashes can be included in the probe request message. For example, if a service hash value corresponding to the first type identification information is included only in the probe request message, the first type advertiser device can determine it as the seeker device supports the first type seeker device only. In this case, the first type advertiser device can transmit information on a service name and an advertisement ID, which are generated based on a service hash value corresponding to the first type identification information, in a manner of including the information in a probe response message.

And, for example, if a service hash value corresponding to the third type identification information is included only in the probe request message, the first type advertiser device can determine it as the seeker device supports the third type seeker device only. In this case, the first type advertiser device can transmit information on a service name and an advertisement ID, which are generated based on a service hash value corresponding to the third type identification information, in a manner of including the information in a probe response message.

And, for example, service hash values corresponding to the first type identification information and the third type identification information can be included in the probe request message as a plurality of service hashes. In this case, the first type advertiser device can determine that the seeker device supports both the first type seeker device and the third type seeker device. In this case, the first type advertiser device can transmit information on a service name and an advertisement ID, which are generated based on at least one of a service hash value corresponding to the first type identification information and a service hash value corresponding to the third type identification information, in a manner of including the information in a probe response message. And, for example, if the service name and the advertisement ID corresponding to service hashes are included in the probe response message, the probe response message may not include WFD IE.

Subsequently, if identification information included in the probe request message corresponds to the WFD IE, the first type advertiser device can determine a seeker device as a second type seeker device [S1750]. Subsequently, the first type advertiser device can transmit a probe response message including identification information based on the WFD IE [S1760]. In this case, as mentioned earlier in FIGS. 11 to 16, if the identification information included in the probe request message corresponds to the WFD IE, the first type advertiser device is able to know that a seeker device corresponds to the second type seeker device. In this case, it may be able to transmit the WFD IE to the second type seeker device in a manner of including the WFD IE in a probe response message as second type identification information. In this case, for example, as mentioned in the foregoing description, the probe response message incudes the WFD IE only and may not include a service hash. Subsequently, the first type advertiser device and the second type seeker device can perform service discovery using the WFD IE.

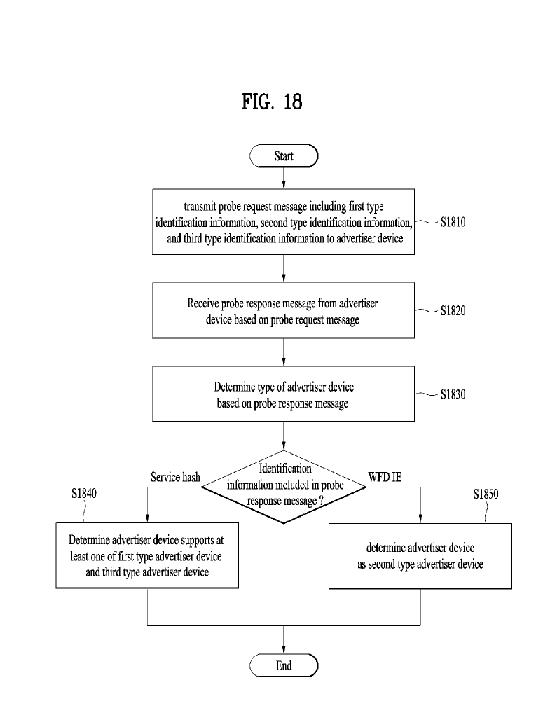

FIG. 18 is a flowchart of a method for a device to support a service using an application service platform according to one embodiment of the present specification.

A first type seeker device can transmit a probe request message including first type identification information, second type identification information, and third type identification information to an advertiser device [S1810]. In this case, as mentioned earlier in FIGS. 11 to 16, the first type identification information and the third type identification information may correspond to identification information based on a service hash. And, the second type identification information may correspond to identification information based on WFD IE.

Subsequently, the first type seeker device can receive a probe response message from the advertiser device based on the probe request message [S1820]. Subsequently, the first type seeker device can determine a type of the advertiser device based on the probe response message [S1830]. In this case, if identification information included in the probe response message corresponds to a service hash, it can be determined as the advertiser device supports at least one of a first advertiser device and a third advertiser device [S1840]. In this case, as mentioned earlier in FIGS. 11 to 16, if a service hash is included in the probe response message, the probe response message may not include WFD IE. In this case, for example, if the probe response message include a service hash corresponding to the first type identification information only, the first type seeker device can determine it as the advertiser device supports the first type advertiser device only. In this case, the first type seeker device can perform service discovery with the first type advertiser device using the first type identification information. And, for example, if the probe response message include a service hash corresponding to the third type identification information only, the first type seeker device can determine it as the advertiser device supports the third type advertiser device only. In this case, the first type seeker device can perform service discovery with the third type advertiser device using the third type identification information. And, for example, if a plurality of service hashes corresponding to the first type identification information and the third type identification information are included in the probe response message, the first type seeker device can determine it as the advertiser device supports both the first type advertiser device and the third type advertiser device. In this case, the first type seeker device can perform service discovery with the advertiser device using at least one of the first type identification information and the third type identification information.

Subsequently, if identification information included in the probe response message corresponds to WFD IE, the first type seeker device can determine the advertiser device as a second type advertiser device [S1850]. In this case, as mentioned earlier in FIGS. 11 to 16, if WFD IE is included in the probe response message, a service name and an advertisement ID corresponding to service hashes may not be included in the probe response message. In this case, as mentioned in the foregoing description, the first type seeker device can perform service discovery with the second type advertiser device using the WFD IE.

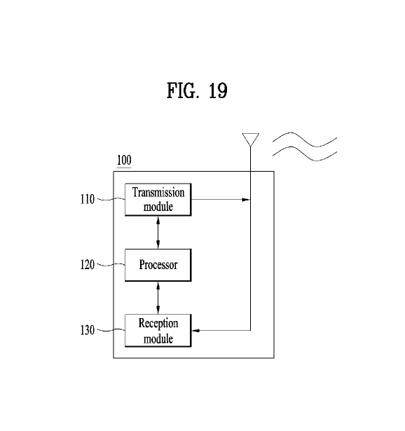

FIG. 19 is a block diagram for a device according to one embodiment of the present specification.

A device may correspond to a first type device supporting ASP capable of using a plurality of interfaces. And, the device may correspond to a second type device performing a neighbor discovery procedure and P2P connection using Wi-Fi Direct interface. And, the device may correspond to a third type device supporting ASP capable of using Wi-Fi Direct interface. In particular, the device can be defined by a different type according to whether or not ASP is supported and whether or not ASP using a plurality of interfaces is used. In this case, the device 100 can include a transmission module 110 configured to transmit a radio signal, a reception module 130 configured to receive a radio signal, and a processor 120 configured to control the transmission module 110 and the reception module 130. In this case, the device 100 can perform communication with an external device using the transmission module 110 and the reception module 130. In this case, the external device may correspond to a different device. For example, the external device may correspond to a different device connected via P2P or an AP or a non-AP connected via WLAN infrastructure. As a different example, the external device may correspond to a base station. In particular, the external device may correspond to a device capable of performing communication with the device 100, by which the present invention may be non-limited. The device 100 can transmit and receive digital data such as contents using the transmission module 110 and the reception module 130.

For example, as mentioned in the foregoing description, the device can play a role of a seeker device. And, the device can play a role of an advertiser device. According to one embodiment of the present specification, if the device plays a role of a first type advertiser, the processor 120 of the device 100 receives a probe request message from a seeker device and can determine a type of the seeker device based on the received probe request message. And, the processor can transmit a probe response message to the seeker device. In this case, the first type advertiser device can perform service discovery with at least one of a first type seeker device and a second type seeker device. And, the probe response message can include identification information corresponding to a type of a seeker device. And, for example, the first type advertiser device can perform service discovery with the third type seeker device as well. When the first type advertiser device performs service discovery with the third type seeker device, the probe response message can include third type identification information corresponding to the third type seeker device.

According to one embodiment of the present specification, if the device plays a role of a first type seeker device, the processor 120 of the device 100 transmits a probe request message to an advertiser device and can receive a probe response message from the advertiser device based on the probe request message. And, the first type seeker device can perform service discovery with at least one of a first type advertiser device and a second type advertiser device. In this case, the probe request message can include both first type identification information and second type identification information.

And, for example, the first type seeker device can perform service discovery with a third type advertiser device as well. In this case, the probe request message can further include first type identification information, second type identification information, and third type identification information.

The embodiments of the present invention may be achieved by various means, for example, hardware, firmware, software, or a combination thereof.

In a hardware configuration, the methods according to exemplary embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

And, both an apparatus invention and a method invention are explained in the present specification and the explanation on both of the inventions can be complementally applied, if necessary.

### INDUSTRIAL APPLICABILITY

Although a method for a device to support discovery in a wireless communication system is explained in the present invention, the method can also be applied to various wireless systems.

What is claimed is:

1. A method of performing service discovery performed by a first type advertiser device in a wireless communication system, the method comprising:
receiving a probe request message from a seeker device;
determining a type of the seeker device based on the received probe request message; and
transmitting a probe response message to the seeker device,
wherein the first type advertiser device performs the service discovery with at least one of a first type seeker device and a second type seeker device, and
wherein the probe response message comprises identification information corresponding to the determined type.

2. The method of claim 1, wherein the first type advertiser device performs the service discovery with the first type seeker device using first type identification information, and
wherein the first type advertiser device performs the service discovery with the second type seeker device using second type identification information.

3. The method of claim 2, wherein the first type identification information corresponds to identification information configured based on a service hash, and wherein the second type identification information corresponds to identification information which is configured based on a WFD IE (Wi-Fi display information element).

4. The method of claim 3, wherein the first type advertiser device determines the seeker device as the first type seeker device and transmits the probe response message in a manner of containing the first type identification in the probe response message when the first type identification information is contained in the probe request message.

5. The method of claim 4, wherein the second type identification information is not contained in the probe request message when the first type identification information is contained in the probe request message.

6. The method of claim 5, wherein the first type advertiser device and the first type seeker device perform the service discovery based on a service application platform when the first type advertiser device performs the service discovery with the first type seeker device.

7. The method of claim 3, wherein the first type advertiser device determines the seeker device as the second type seeker device and transmits the probe response message in a manner of containing the second type identification in the probe response message when the second type identification information is contained in the probe request message.

8. The method of claim 7, wherein the first type identification information is not contained in the probe request message when the second type identification information is contained in the probe request message.

9. The method of claim 1, wherein the first type advertiser device further performs the service discovery with a third type seeker device based on third type identification information, and
wherein the third type identification information is contained in the probe response message when the first type advertiser device determines the seeker device as the third type seeker device.

10. The method of claim 9, wherein the third type identification information is configured based on a service hash.

11. A first type advertiser device performing service discovery in a wireless communication system, comprising:
a reception module configured to receive information from an external device;
a transmission module configured to transmit information to an external device; and
a processor configured to control the reception module and the transmission module,
wherein the processor is further configured to:
receive a probe request message from a seeker device,
determine a type of the seeker device based on the received probe request message,
transmit a probe response message to the seeker device,
wherein the first type advertiser device performs the service discovery with at least one of a first type seeker device, and
a second type seeker device and wherein the probe response message comprises identification information corresponding to the determined type.

12. A method of performing service discovery performed by a first type seeker device in a wireless communication system, the method comprising:
transmitting a probe request message to an advertiser device; and
receiving a probe response message from the advertiser device based on the probe request message,
wherein the first type seeker device performs the service discovery with at least one of a first type advertiser device and a second type advertiser device, and
wherein the probe request message comprises both first type identification information and second type identification information.

13. The method of claim 12, wherein the first type seeker device performs the service discovery with a third type advertiser device and wherein the probe request message further comprises third type identification information together with the first type identification information and the second type identification information.

14. The method of claim 12, further comprising the step of determining a type of the advertiser device based on the received probe response message.

15. A first type seeker device performing service discovery in a wireless communication system, comprising:
a reception module configured to receive information from an external device;
a transmission module configured to transmit information to an external device; and
a processor configured to control the reception module and the transmission module,
wherein the processor is further configured to:
transmit a probe request message to an advertiser device,
receive a probe response message from the advertiser device based on the probe request message,
wherein the first type seeker device performs the service discovery with at least one of a first type advertiser device, and
a second type advertiser device and wherein the probe request message comprises both first type identification information and second type identification information.
